(19) United States
(12) Patent Application Publication
(10) Pub. No.: US 2013/0039379 A1
(43) Pub. Date: Feb. 14, 2013

(54) ELECTRODE SUPPORT ARM SYSTEM

(71) Applicants: Rolf Best, Gladbeck (DE); Peter Starke, Duisburg (DE); Andreas Schuering, Muelheim (DE)

(72) Inventors: Rolf Best, Gladbeck (DE); Peter Starke, Duisburg (DE); Andreas Schuering, Muelheim (DE)

(21) Appl. No.: 13/583,654

(22) PCT Filed: Mar. 7, 2011
(86) PCT No.: PCT/EP11/53384

§ 371 Date: Oct. 22, 2012

(30) Foreign Application Priority Data
Mar. 10, 2010 (DE) 10-2010-010-994.0
Nov. 17, 2010 (DE) 10-2010-052-086.1

(51) Int. Cl. H05B 7/10

(52) U.S. Cl. 373/94

(57) ABSTRACT

The invention relates to an electrode support arm system for metallurgical furnaces, having an electrode arm (1) having an electrode support arm head (13) implemented as an electrode support device at the front part thereof, designed as a hollow profile having a wall formed at least partially of conductive material having high conductivity, through which a coolant can be guided. According to the invention, flow guide plates and/or displacers are disposed with the electrode support arm (1) implemented as a hollow profile and within the electrode support device implemented on the electrode support arm head (13), by which the coolant flow can be channelized and affected with respect to flow speed, such that optimal flow speeds of the coolant are present at all locations within the electrode support arm (1) and the electrode support arm head (13), wherein highly thermally loaded regions, such as the contact surfaces on the electrode support arm head (13), can be intensively cooled than other, less intensely thermally loaded regions of the electrode support arm (1).

The invention relates to an electrode support arm system preferably for electrical furnaces and ladle furnaces, for supporting graphite electrodes.

The electrode support arms transmit the electric energy necessary for the smelting process. The vertical movement is realized with a hydraulic or electromechanical lifting system on which the electrode support arm is secured. Reversible clamping devices enable loosening of the graphite electrodes which are adjusted according to their consumption.

The known electrode support arms are completely flushed with a through-flow of water for dissipation of heat, wherein the cooling potential of the cooling medium is not satisfactorily used.

EP 0594272 discloses an electrode support arm that is cooled through channels formed in a hollow profile. Because of high manufacturing costs and, when necessary, expensive repair works, this system could not be implemented in practice.

The clamping devices, which are used up to now, are difficult to handle because of their large dimensions. During monitoring and repair works often, because of a difficult accessibility and because of lacking of contact surfaces, a complete disassembly in a shop becomes necessary. Therefore, a complete dismounting of the electrode support arm is necessary. In conventional clamping devices, constructively, disc springs having a small diameter and a small excursion, are used which, because of an unfavorable force/spring excursion ratio, do not insure a reliable clamping.

Often, a problem consists in sparking-over within the clamping device, in so-called arcing. Contemporary solutions contemplate using of corresponding isolation materials. Complications arise from environmental conditions for the isolation materials because they become prone to heat, dust and water from electrode spraying.

The connection of the electrode support arm with the lifting column is effected with screws of magnetizable materials, e.g., having a grade 8.8. or 10.9. With modern powerful smelters, the screw materials can be inadmissibly heated because of strong magnetic fields, so that their strength is reduced. Likewise, the surrounding isolation materials can be damaged by heat, which can lead to arcing.

The object of the invention is to improve the electrode support arm system.

This object is achieved with an electrode support arm system for metalized systems, comprising an electrode support arm having, at a front end thereof, an electrode support arm head formed an electrode support device, and designed a as hollow profile having a wall formed at least partially of a conductive material having a high conductivity and through which a coolant can be guided, characterized in that,

flow guide plates and/or displacers are arranged within the electrode support arm formed as the hollow profile, and within the electrode support device formed as the electrode support arm head,

with which the coolant flow can be channeled and influenced with regard to flow velocity so that at each location within the electrode support arm and electrode support arm head, the optimal flow velocities of the coolant are available,

whereby highly thermally loaded regions, such as contact surfaces on the electrode support arm head, can be cooled more extensively than other less intensively thermally loaded regions of the electrode support arm.

Due to insertion of flow guide plates and/or displacers, at each location of the electrode support arm, optimal flow velocities of the cooling medium are available, so that an optimal heat dissipation is insured. Also, the constructional elements prevent eventual deposits from the cooling medium because the through-flow velocity within the electrode support arm can be kept relatively constant.

Further, the electrode support arm system is characterized in that the support arm is formed of aluminum, steel with a coating of a conductive material, such as, e.g., copper, or any other material having a good current conductivity, and in that an integrated voltage-free electrode clamping device is used which makes possible to integrate it in the electrode support arm without isolation parts.

The clamping device is fitted within the electrode support arm in a modular manner so that the contact surfaces of the disc springs, in their stressed condition, engage but are not fixedly connected with the lifting cylinder. This device provides for a construction without sensitive isolation materials. In case of repair, the components, because of their compact modular structure, can be pulled out or fitted in without big expenses and without dismounting of the electrode support arm.

The construction of the clamping device enables to determine and to monitor the condition of the electrode pressure force. Thereby the holding force, which is generated by the disc spring package, is determined and a warning signal is generated when the predetermined minimum holding force falls short, so that a necessary exchange of the disc spring package can be timely effected. Thus, it is insured that properly operating disc springs are not removed prematurely or, at reduced holding force, too late, which can result in an undesirable arcing between the clamping device and the graphite electrode.

By integration of a safety device for the spray cooling system, which is disclosed in European Patent EP 1 825 716 B1, the damage of the electrode support arm and production interruptions can be prevented by using the electrode breakage monitoring described in the patent.

By using high-alloyed non-magnetizable materials, the screw connection is not affected by magnetic field of the electrical arc furnace so that resulting therefrom external heat is eliminated. Thus, the screw connections are not subjected to any strength-reducing operational conditions. Likewise, isolation is not subjected to any uncontrolled thermal load.

The invention will be explained in detail below with reference to the drawings.

The drawings show:

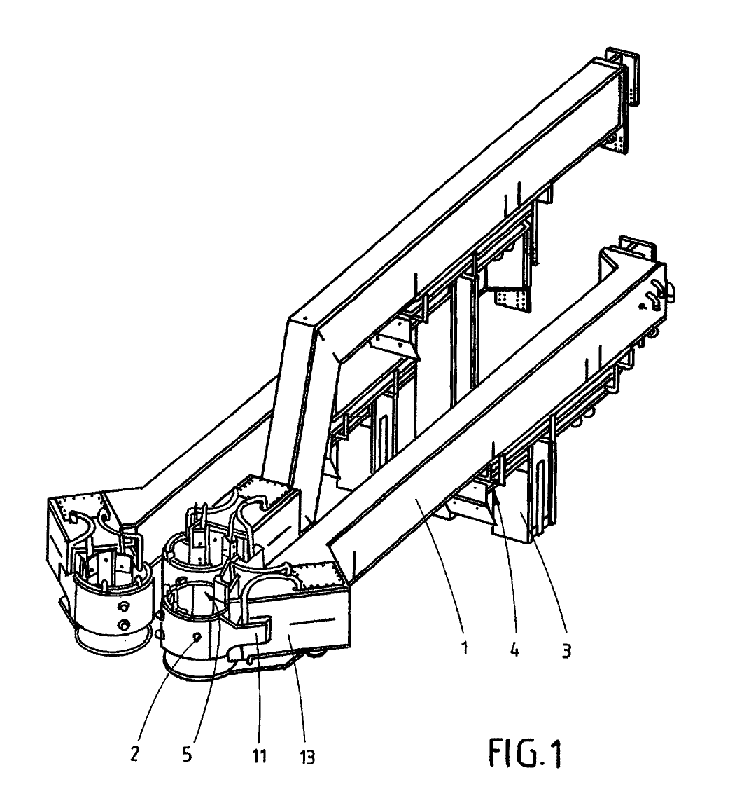

FIG. 1 a schematic view of an electrode support arm system;

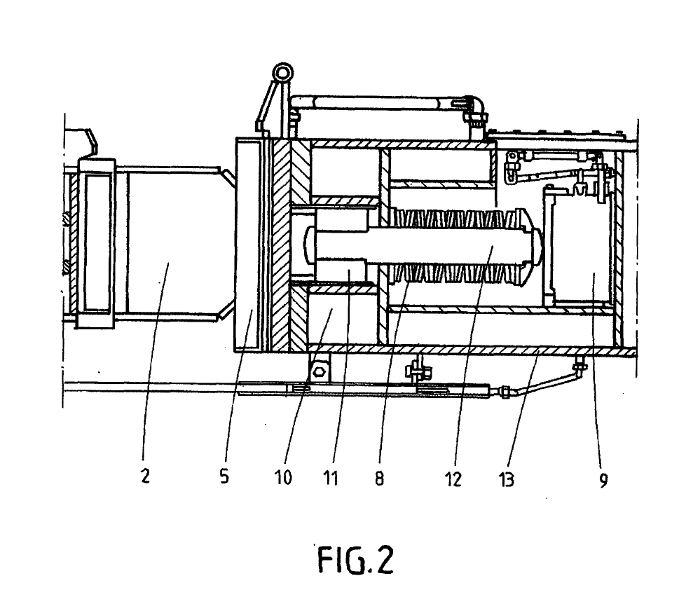

FIG. 2 a cross-sectional view of a holding device; and

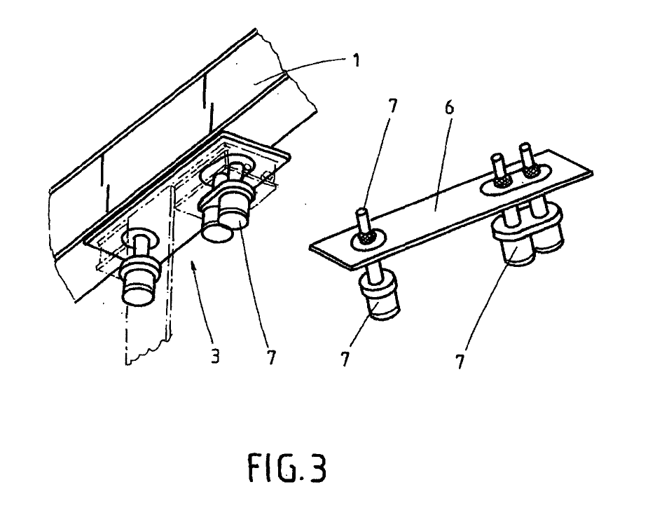

FIG. 3 a connection of the electrode support arm/guide column.

In the present case, there are provided three electrode support arms which essentially consist of welded hollow profiles. A guide column 3 is associated with each electrode arm, with a head region of a respective support arm being releasably connected with a respective guide column. An example of the connection is shown in FIG. 3 in which an isolation plate 6 arranged between the head of the guide column and the electrode support arm, is shown. The actual releasable connection is carried out with screws 7 of antimagnetic material.

The front region of the electrode support arm 1, i.e., the electrode support arm head 13 with an electrode holder 2 is shown in detail in FIG. 2.

The holder 2 encircles the electrode (not shown here) over a major portion of its circumference and presses it against a contact cheek 5.

As shown in the cross-sectional view of FIG. 2, the holder 2, which encircles the electrode, is operationally connected with its arms 11 with a disc spring package 8 arranged in the interior of the front electrode support arm 13, whereby the disc spring package 8 presses the holder and, thus, the electrode against the contact cheek 5.

The connection between the holder 2 or its arms 11 is effected by a bolt 12 extending through the disc spring package.

At the rear side, i.e., at the end remote from the holder 2, the bolt 12 is operationally connected with a lifting cylinder 9 which displaces bolt 12 in a direction of the holder against the pressure of the disc spring package 8, so that the holder 2 somewhat opens, whereby an exchange of the electrode or lowering it in accordance with electrode consumption can be effected.

The electrode support arm 1 and its front electrode support arm head 13, to which the holder 2 is, respectively connected, is water-cooled, wherein it is essential that the cooling water flow is so guided in the interior of the electrode support arm and the electrode support arm head that the flow velocity in each point of the electrode support arm is optimal so that an optimal heat dissipation is achieved. This is effected with baffles arranged in the interior of the electrode support arm, such as flow guide plates, channels, displacers. In FIG. 2, only channels 10 which cool the region adjacent to the contact cheek 5 of the front electrode support arm head, is clearly shown.

1. An electrode support arm system for a metallurgical furnace, comprising an electrode support arm (1) having, at a front end thereof, an electrode support arm head (13) formed an electrode support device, and designed as hollow profile having a wall formed at least partially of a conductive material having a high conductivity and through which a coolant can be guided, characterized in that,
flow guide plates and/or displacers are arranged within the electrode support arm formed as the hollow profile, and within the electrode support device formed as the electrode support arm head (13),
with which the coolant flow can be channeled and influenced with regard to flow velocity so that at each location within the electrode support arm (1) and at each location within the electrode support arm head (13), optimal flow velocities of the coolant are available,
whereby highly thermally loaded regions, such as contact surfaces on the electrode support arm head (13), can be cooled more extensively than other less intensively thermally loaded regions of the electrode support arm (1).

2. An electrode support arm system according to claim 1,
characterized in that,
the electrode support arm (1) is formed of aluminum, steel with a coating of a conductive material, such as, e.g., copper, or any other material having a good current conductivity.

3. An electrode support arm system according to claim 1,
characterized in that
the electrode support arm head (13) arranged on the front end of the electrode support arm (1), is formed as an integrated voltage-free electrode clamping device.

4. An electrode support arm system according to claim 1,
characterized in that,
the electrode clamping device has an electrode-encircling holder (2) and at least one contact cheek (5), as well as a disc spring package (8) that presses the electrode against the contact cheek, and a lifting cylinder (9) cooperating with the disc spring package and with which pressure of the disc spring package (8) is lifted for exchange or lowering of the electrode.

5. An electrode support arm system according to claim 1,
characterized in that,
the disc spring package (8) is operationally connected with the lifting cylinder (9) but is not fixedly connected with the cylinder (9).

6. An electrode support arm system according to claim 1,
characterized in that,
condition of the electrode pressure force is determined and monitored with a sensor, and that a signal of necessary exchange of the disc spring package is generated when a predetermined minimum holding force produced by the disc spring package (8) falls short.

7. An electrode support arm system according to claim 1,
characterized in that,
the electrode support arm (1) is releasably secured on a guide column (3), wherein the connection elements are formed of a high-alloyed non-magnetizable material.
